(19) United States
(12) Patent Application Publication
(10) Pub. No.: US 2015/0347507 A1
(43) Pub. Date: Dec. 3, 2015

(54) HIERARCHICAL QUERY PLANS IN AN ELASTIC PARALLEL DATABASE MANAGEMENT SYSTEM

(71) Applicant: Tesora, Inc., Cambridge, MA (US)

(72) Inventors: Mrithyunjaya Annapragada, Bolton, MA (US); Benjamin Rousseau, Somerville, MA (US)

(73) Assignee: Tesora, Inc., Cambridge, MA (US)

(21) Appl. No.: 14/288,629

(22) Filed: May 28, 2014

(51) Int. Cl. G06F 17/30

(52) U.S. Cl. CPC G06F 17/30463

(57) ABSTRACT

Methods, apparatus, and products are disclosed for the purposes of representing query plans for a query presented to a database in a manner generally referred to as an “EXPLAIN PLAN”, including query execution steps, query execution sequences, alternate query execution steps, and alternate query execution sequences for the query presented to the database management system, and for query plans, query execution steps, and query execution sequences for the execution of a parent query execution step.

### CROSS-REFERENCE TO RELATED APPLICATIONS

The present application is related to the following commonly assigned U.S. patent application Ser. No. 13/906,556, which was filed on May 31, 2013, by Annapragada et al. for an “Adaptive Multi-Client Saas Database” and Attorney Docket Number 111055-0005, filed on the same date herewith entitled “Methods and Apparatus for Specifying Query Execution Plans in Database Management Systems” also by Annapragada et al., both of which are hereby incorporated by reference in their entirety.

### BACKGROUND OF THE INVENTION

1. Field of the Invention

This patent application relates generally to data management systems, and more specifically to a parallel and shared-nothing relational database management system.

2. Background Information

Relational Database Management Systems are sometimes referred to as RDBMS.

Distributed RDBMS that are implemented according to a “Shared Nothing” system architecture are sometimes referred to as Parallel Database Servers or parallel databases (in contrast to Symmetric Multiprocessing (SMP) Database Servers).

In Shared Nothing or Parallel Databases, many logical computer servers (often called nodes or operational nodes) participate in the query processing. The data are distributed amongst these nodes and each node has exclusive access to a subset of the data, hence the name “Shared Nothing”. This is in contrast to other architectures such as “Shared Disk”, “Shared Memory” or “Shared Everything”. Nodes in the Parallel Database are grouped together in the form of logical entities called “Nodegroups”.

Data in the Parallel Database is stored in tables which are associated with one or more Nodegroups, and the data in the tables is stored on the nodes that are part of the associated nodegroups.

When a parallel database receives a query, each node in the parallel database performs some set of operations based on the subset of data that it has access to. The results of these various operations are then synthesized to produce the results expected by the requestor.

The process of generating this set of operations is called query planning and the result of the query planning process is a query plan.

### SUMMARY

Query planning in a parallel database management system results in a “Query Plan” that consists of “Query Execution Steps” and a “Query Execution Sequence”.

The “Query Execution Steps” (abbreviated as QESS) consist of operations that are performed by the database management system to produce the results expected of the query. Each step is called a “Query Execution Step” and abbreviated as QES. A QES consists of an operation and a location where the operation is to be performed. An operation could contain one or more commands that the database instance must perform in the specified order.

The “Query Execution Sequence” defines the relationships and dependencies between the QESS. The Query Execution Sequence is abbreviated as QESEQ.

The Query Execution Steps themselves are executed by one or more (or in some cases all) of the nodes in the database management system, each QES according to the locations specified therein.

In some cases, the nodes consist of software components that in turn generate a query plan for the QES assigned to it.

Since there is no guarantee that (and in fact, it is almost certain that) each node has the same data, it is very likely that each node will generate a different query plan for its execution of a given QES. The query plan created by each of these underlying databases is called a Subordinate Query Plan (SQP).

The RDBMS' provides extensions to the Structured Query Language (SQL) that allow a user to obtain a list of steps including Subordinate Query Plans that will be used by the RDBMS to execute a query. This is a command may be called “EXPLAIN” or by other names.

### BRIEF DESCRIPTION OF THE DRAWINGS

The invention description below refers to the accompanying drawings, of which:

FIG. 1 provides a graphical representation of a parallel database.

FIG. 2 provides a graphical representation of a Query Plan.

FIG. 3 provides a graphical representation of a query plan for a sample query.

FIG. 4 provides a subordinate query plan (SQP) generated by the database on two of the nodes in the distributed RDBMS for executing one of the QES assigned to it.

FIG. 5 provides a textual representation of an EXPLAIN Query Plan.

FIG. 6 provides a flowchart depicting a Query Planning process.

### DETAILED DESCRIPTION OF AN ILLUSTRATIVE EMBODIMENT

In parallel databases, each node has a subset of the complete data set and the process of query execution by the parallel database requires some and often all nodes in the parallel database to perform some queries on their subset of the data.

When presented with a query, the Query Execution Steps (QESS) and Query Execution Sequence (QESEQ) define what the parallel database will do in order to respond to that query.

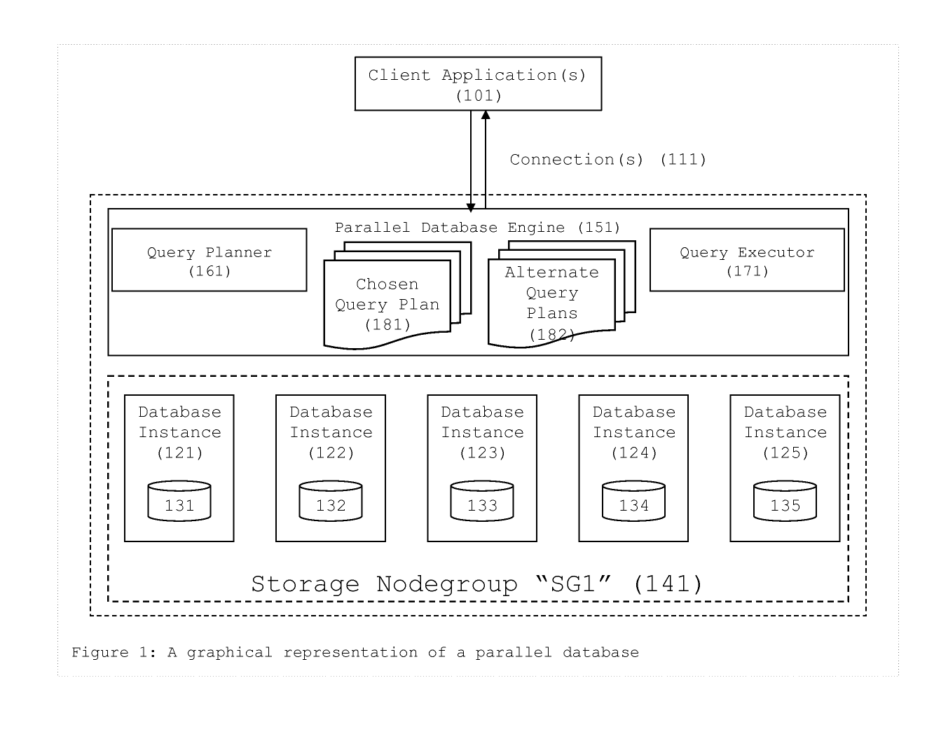

In parallel databases, as illustrated in FIG. 1, one or more Client Applications (101) establish one or more connections (111) to a Parallel Database Engine (151). The Parallel Database Engine (151) consists of a Query Planner (161) and a Query Executor (171). A query is sent by a Client Application to the Parallel Database Engine over a Connection. The Query Planner constructs several Query Plans and selects one as, the Chosen Query Plan (181), which it delivers to the Query Executor (171). The other Query Plans that were not selected become Alternate Query Plans (182).

The Query Executor inspects the Chosen Query Plan and then performs various Query Execution Steps according to a Query Execution Sequence on the Database Instances (121, 122, 123, 124, and 125), each of which may be MySQL or Oracle, or PostgreSQL or some other database management system, and each of which perform the required operation(s) on the data to which they have exclusive access (131, 132, 133, 134 and 135 respectively). The Database Instances (121, 122, 123, 124, and 125) along with their storage (131, 132, 133, 134, and 135) are nodes in the Parallel Database and are grouped together as a logical entity called a Storage Nodegroup (141), and each of these nodes may be a physical or a virtual server or some combination thereof.

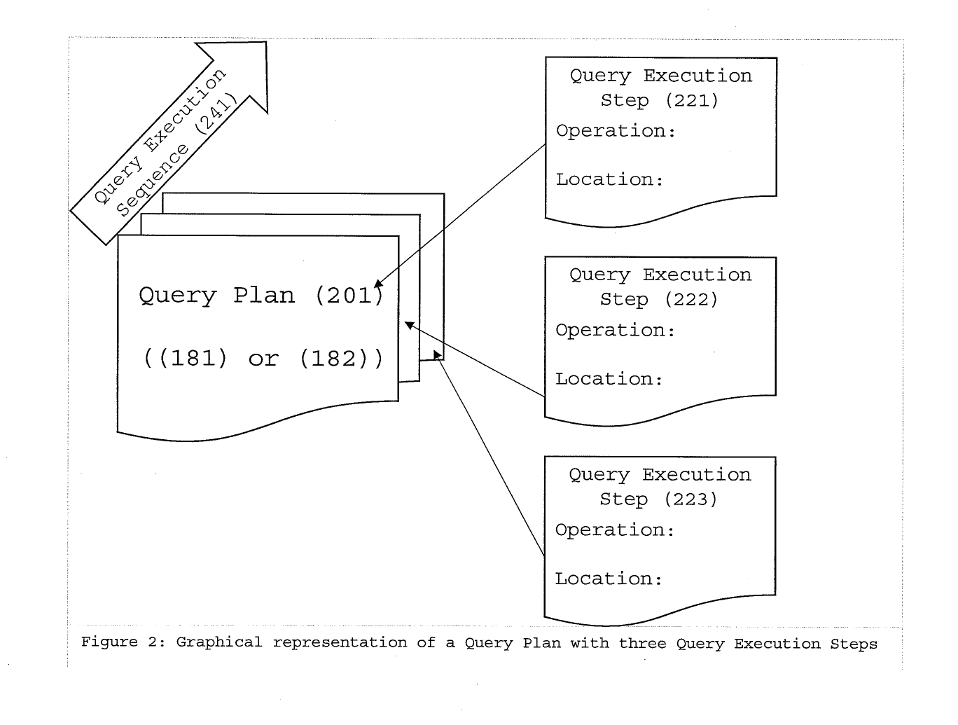

FIG. 2 provides a graphical representation of an example Query Plan (201) with three Query Execution Steps (221, 222 and 223). As depicted, each Query Execution Step contains an Operation and a Location and the steps are to be executed in a sequence defined by the Query Execution Sequence (241).

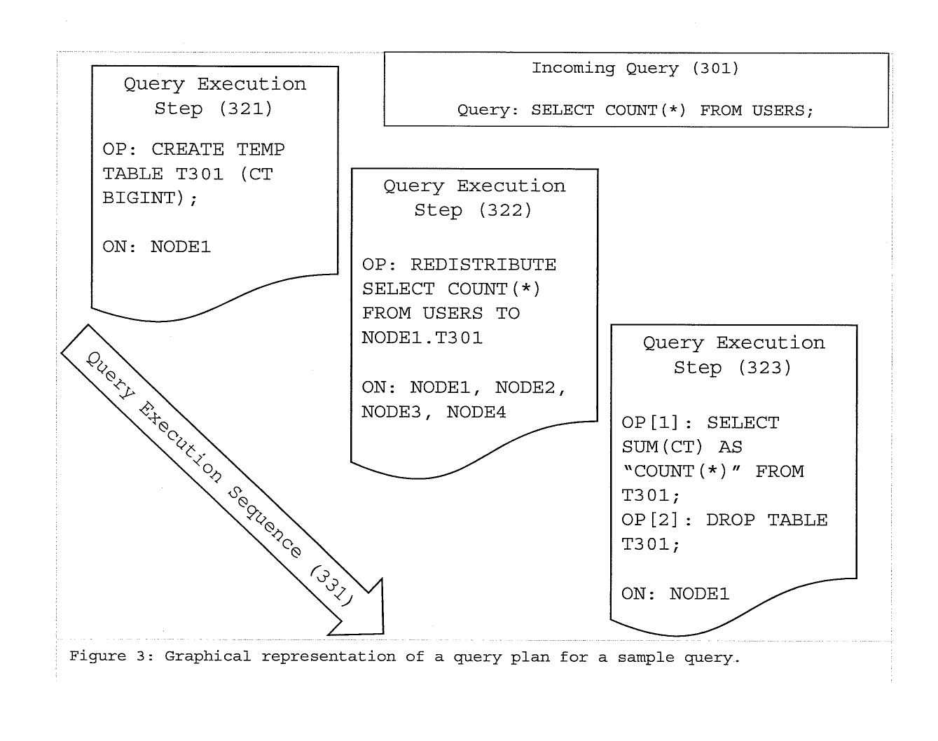

FIG. 3 provides a detailed graphical representation of an example Query Plan for a Sample Query. The Incoming Query (301) was submitted by a Client Application to the Parallel Database Engine. A Query Planner constructed a Query Plan consisting of the Query Execution Steps (321, 322 and 323), and a Query Execution Sequence (331). Query Execution Steps 321 and 322 contain an operation with only one command but Query Execution Step 323 contains an operation with two commands which must be executed sequentially. Further according to the example Query Plan, Query Execution Steps 321 and 323 must be executed on a location node NODE1 while Query Execution Step must be performed on a location node NODE1, NODE2, NODE3 and NODE4. The Query Execution Sequence (331) indicates that 321 must be performed before 322 and 322 must be performed before 323. It should be understood that FIG. 3 is just one possible example of a Query Plan and that many other Query Plans with different execution constraints are possible, depending on the Query Planner 161, the Executor 171, the query in question, and other factors.

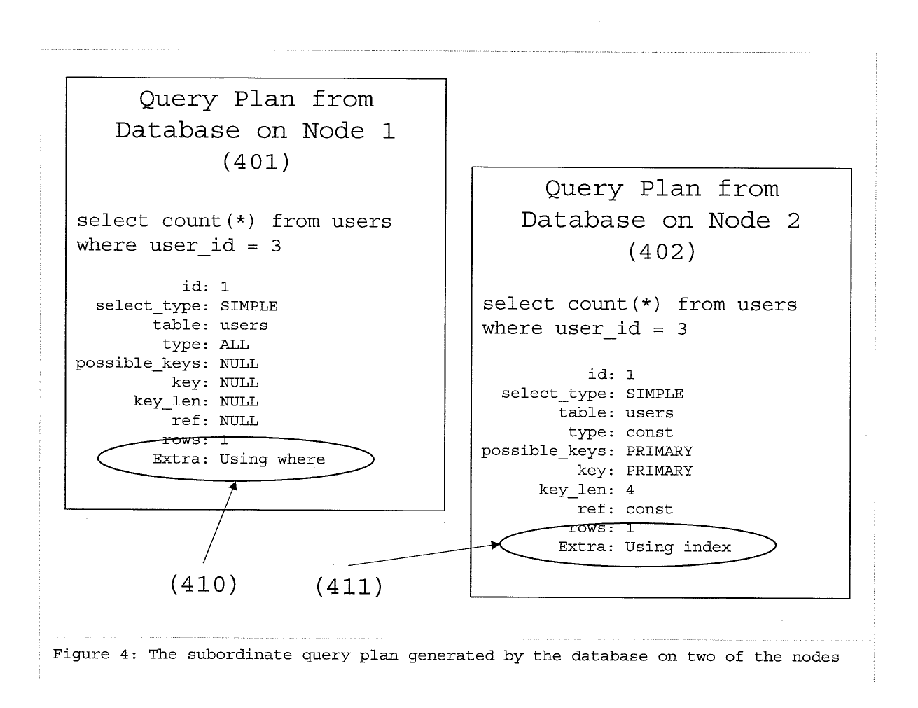

FIG. 4 illustrates the Subordinate Query Plan generated by an example MySQL database (which are database instances) instances running on node NODE1 and NODE2 in response to the same query “select count(*) from users where user_id=3”. Query Plan (401) shows the plan on NODE1 and Query Plan (402) shows the plan on NODE2. Observe that NODE1 does not use an index (see 410 and 411 labeled “Extra” in this figure) while NODE2 does.

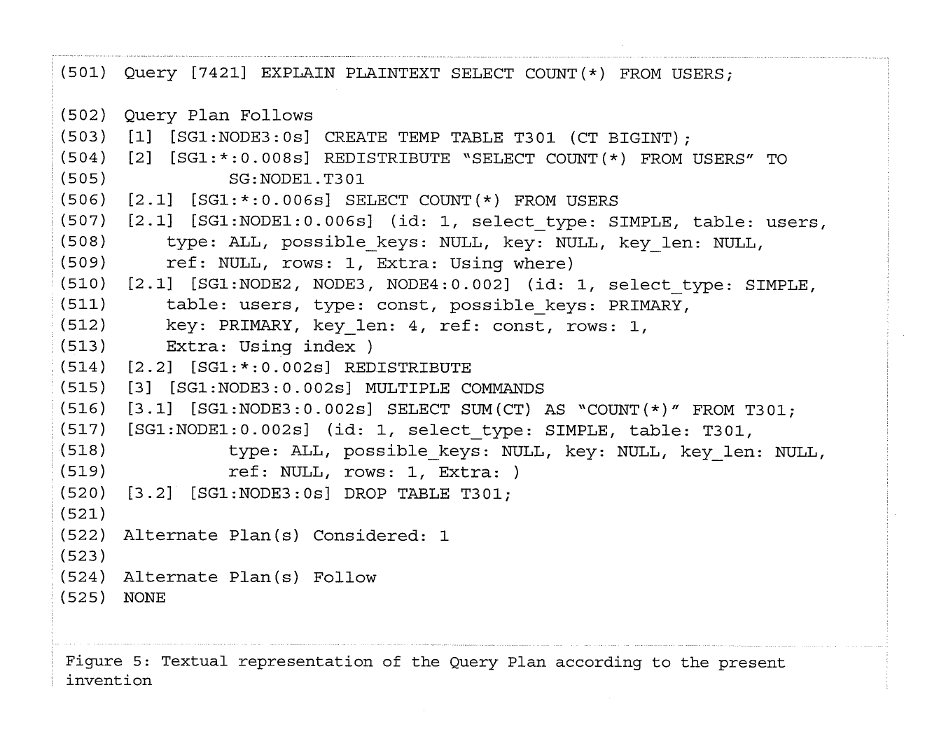

FIG. 5 provides a textual representation of the Query Plan. The incoming query is presented (501) along with a descriptive tag “Query” and the identifier “[7421]” which identifies the Client Application Connection. The Query Plan follows this (502). Lines (503), (504) and (515) provide the three Query Execution Steps. There are two parts of step 2 and those are shown as [2.1] (506) and [2.2] (514). Finally step 3 has two parts [3.1] (516) and [3.2] (520). The Query Planner considered no alternate plans (522) and if there were alternate plans they will be listed in the section “Alternate Plan(s) Follow” (524). Query Execution Step 1 (503) is indicated as being executed on the node “SG1:NODE3” and is expected to take a total of 0 seconds. This is shown as [SG1:NODE3:0]. The operation itself follows “CREATE TEMP TABLE T301 (CT BIGINT)”. Query Execution Step 2 starting on (504) is indicated as being performed on SG1:* (on all the nodes in Storage Group SG1) and is expected to take 0.008 seconds. It consists of two operations [2.1] and [2.2] which start on (506) and (514) respectively. Operation[2.1] is performed differently on different nodes and (507), (508), and (509) indicates the subordinate query plan (SQP)_{—} for execution on SG1:NODE1, while (510), (511), (512) and (513) indicate the subordinate query play (SQP) for execution on NODE2, NODE3, and NODE4. The SQP on NODE1 will take 0.006 seconds and the SQP on the other nodes will take 0.002 seconds. Since both (507) and (510) indicate they are part of Operation[2.1] they can be executed at the same time but they must be executed before [2.2] (514). The second part of Query Execution Step 2 (504) is the REDISTRIBUTE that occurs (514) which is expected to take 0.002 seconds. The time for Query Execution Step 2 (0.008 seconds, (504)) is computed from the slowest path on [2.1] (506) and [2.2] (514). Finally Query Execution Step [3] consisting of two operations [3.1] (516) and (520).

The Query Execution Sequence (QES) identifies the dependencies between the various steps in the Query Execution Steps of a Query Plan (and each of the Alternate Query Plans). If a Query Plan consisted of some Query Execution Steps A and B, and further if Query Execution Step A was defined to be “dependent on” Query Execution Step B, then Query Execution Step B must be completely executed before Query Execution Step A can commence.

The relationship of dependence is therefore transitive, in that if A is dependent on B and B is dependent on C, then A is necessarily dependent on C.

The Query Executor (171) is free to execute Query Execution Steps in any order it so desires so long as the dependency rules are respected.

DBMS often implement a command (which may be called an EXPLAIN or SET SHOWPLAN) whose purpose is to show the client how the DBMS would execute a database command. An EXPLAIN or similar command provides the DBMS with a query that the client would like the database to analyze and further explain. In response the DBMS determines the steps involved in Query Planning and instead of executing those steps, merely returns the steps and the Query Plan (and other information related to the Query Planning process) to the requestor in a human readable form.

During the Query Planning process, the Query Planner may use some heuristics and/or algorithms to determine a “cost” for each Alternative Query Plan. This cost is a metric that helps the Query Planner assess such things as the resources that the Query Plan will consume, the total amount of time it may take, and so on. It does this by understanding how each of the operational nodes will perform the commands that are going to be sent to them according to the Query Plan, and then assessing any additional costs that may be incurred. In this manner, the Query Planner can associate a cost to each Alternate Query Plan. In this process, the cost is not necessarily a single number but rather a composite metric that could include such things as the number of nodes that would be involved, the amount of data that would have to be redistributed, the number of I/O that would likely be generated, the amount of CPU time that would be consumed, the amount of memory that would be consumed, the total amount of time for the execution, and so on. The Query Planner then chooses one of the plans that it believes to have the best overall cost.

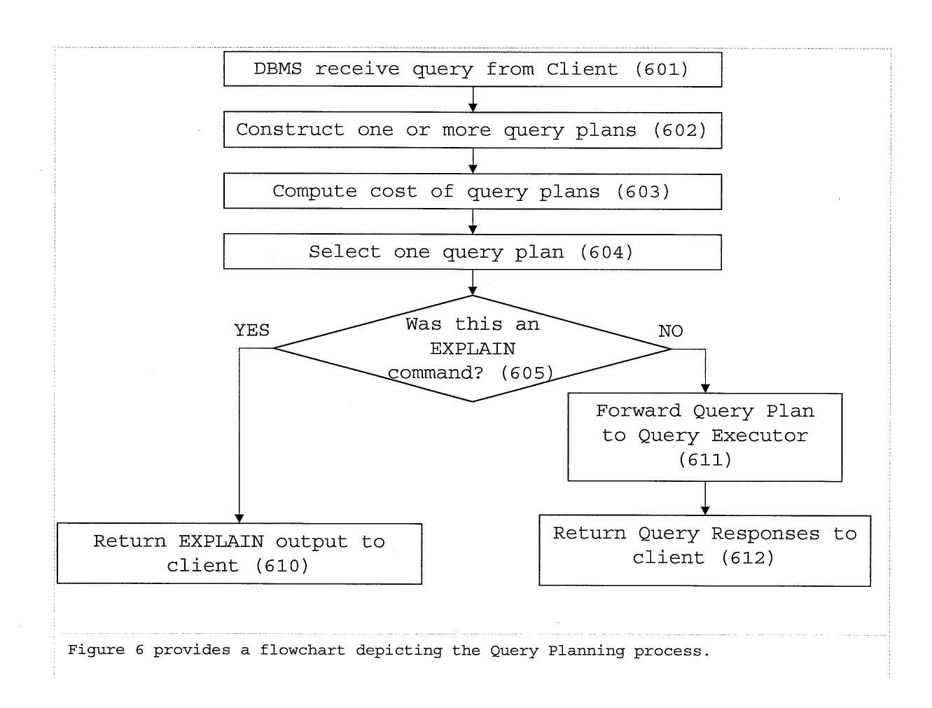

This is illustrated in FIG. 6. The DBMS receives a query from the Client (601) and the Query Planner constructs one or more Query Plans (602). It then computes the cost of each one (603) and selects one which has the ideal cost metric (604). If the query from the Client was an EXPLAIN (605), the DBMS returns the EXPLAIN output to the Client (610). If on the other hand the query was not an EXPLAIN command (605) then the Query Planner forwards the selected Query Plan to the Query Executor (611) and the Query response is returned to the client (612).

The RDBMS may support multiple formats of the EXPLAIN output. FIG. 5 shows one such output. Since the command invoked (501) was “EXPLAIN PLAINTEXT”, the command provided a plain text format of the output.

Similarly the EXPLAIN command may return its output as rows of data in a well-defined tabular format. A representation in a tabular fashion is particularly convenient as it can be returned to a client application as a result set of a query. In this case, the geometry of the result set (the column names and their respective datatypes and meanings) will be well defined and known to the client application.

Similarly the EXPLAIN command may return its output in a graphical form. In this case the resulting graphical representation may be provided to the Client Application as a file in some previously agreed upon location, or as a binary object (BLOB), or some other suitable representation.

It should be understood that the embodiments described above are but one example and the system and methods may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other physical or virtual elements executing the firmware, software, routines, instructions, etc.

It also should be understood that the flow, block and network diagrams may include more or fewer elements, be arranged differently, or be represented differently. But it further should be understood that certain implementations may dictate the flow, block and network diagrams and the number of block and network diagrams illustrating the execution of the embodiments be implemented in a particular way.

Accordingly, further embodiments may also be implemented in a variety of computer architectures, physical machines, virtual machines, cloud services, and/or some combination thereof, and thus the computer systems described herein are intended for purposes of illustration only and not as a limitation of the embodiments.

Thus, while this invention has been particularly shown and described with references to example embodiments thereof, it will be understood by those skilled in the art that various changes in form and details may be made therein without departing from the scope of the invention as encompassed by the appended claims.

What is claimed is:

1. A database management system comprising:
a network interface, for receiving database queries from two or more client applications, the client applications operating on two or more user client computers, the system providing a least one connection into the system for each such client application;
a group of two or more operational nodes for executing the queries as database operations, each operational node implemented as a logical collection of software components that execute on one or more physical machines;
one or more client applications establish connections with the system and interact with the system in some query language;
one or more operational nodes for storing data in tables, operating as storage nodes, and collectively referred to as a storage nodegroup;
a Query Planner that analyzes queries submitted by one of the client applications and transforms the queries into a Chosen Query Plan that is to be executed by a Query Executor;
the Chosen Query Plan comprising an ordered list of Query Execution Steps indicating an execution order, the execution order being a Query Execution Sequence, and including locations where individual steps of the Chosen Query Plan are to be executed;
the Query Execution Sequence further identifying one or more dependencies amongst various steps in the Query Execution Steps, the dependencies such that at least one step must be executed before at least one other step;
the Query Executor performing operations specified in the Query Execution Steps according to the Query Execution Sequence;
in response to a command and an associated query, the Query Planner constructing Query Plans for the query;
the software component on each operational node further inspecting and performing operations commanded by the Query Executor;
the software component on each operational node independently generating a Subordinate Query Plan (SQP) that executes in response to the command that it receives from the Query Executor, at least two or more of the SQPs being dependent upon data stored in respective tables in the operational nodes, with the SQP for a first operational node being different from the SQP for a second operational node,
1. each operational node returning the SQP that it independently generates to the Query Planner;
the Query Planner further returning information to one or more of the client applications as output in some human readable format, the output including
2. the Query Execution Steps of the chosen Query Plan;
3. an identification of the operational nodes where individual steps of the chosen Query Plan are to be executed;
the Query Execution Sequence of the chosen Query Plan;
4. two or more of the SQPs generated by the operational nodes, including information indicating which of the steps and which of the operations within a step are to be executed before other steps, and information indicating dependencies between Query Execution Steps and operations within a Query Execution Step that comprise the two or more SQPs for corresponding operational nodes.

2. The system of claim 1 where
the output lists a number of alternate Query Plans constructed that are not the chosen Query Plan; and
the output lists details of zero or more of the alternate Query Plans constructed.

3. The system of claim 1 where
the output lists a cost of the Query Plan; and
the output lists a costs of zero or more of the alternate Query Plans.

4. (canceled)

5. The system of claim 1 where two or more forms of output depend on modifiers provided in the command, including but not limited to a plaintext format, a tabular format, a graphical format, as a picture file, and as a result set in a specified geometry.

6. The system of claim 1 where the command to produce output of a Query Plan is an “EXPLAIN” command.

7. The system of claim 1 where the command to produce output of a Query Plan is a “SET SHOWPLAN” command.

8. A method for operating a database management system comprising:
receiving database queries via a network interface from two or more client applications, the client applications operating on two or more user client computers, the network interface providing a least one connection into the system for each such client application;
executing the queries as database operations on a group of two or more operational nodes, each operational node implemented as a logical collection of software components that execute on one or more physical machines;
one or more client applications interacting with the database management system in a query language;
one or more operational nodes for storing data in tables, operating as storage nodes, and collectively referred to as a storage nodegroup;
analyzing queries submitted by one of the client applications via a Query Planner and transforming the queries into a Chosen Query Plan that is to be executed by a Query Executor;
the Chosen Query Plan comprising an ordered list of Query Execution Steps indicating an execution order, the execution order being a Query Execution Sequence and specifying locations where individual steps of the Chosen Query Plan are to be executed;
the Query Execution Sequence further identifying one or more dependencies amongst various steps in the Query Execution Steps, the dependencies such that at least one step must be executed before at least one other step;
the Query Executor performing operations specified in the Query Execution Steps according to the Query Execution Sequence;
the Query Planner constructing Query Plans for the query in response to a command and an associated query, and further returning information to one or more of the client applications as output in some human readable format;
the output listing the Query Execution Steps of the chosen Query Plan;
the output including locations where individual steps of the chosen Query Plan are executed;
the output identifies which of the steps, and which of the operations within a step can be executed at the same time, and the dependencies between Query Execution Steps, and operations within a Query Execution Step that comprise two or more of the SQPs for corresponding operational nodes;
the output listing the Query Execution Sequence of the chosen Query Plan;
the software component on each operational node further inspecting and performing operations commanded by the Query Executor;
the software component on each operational node further generating a Subordinate Query Plan that executes in response to the command that it receives from the Query Executor; and
the output further including the one or more Subordinate Query Plans (SQPs) constructed by the software component on two or more of the operational nodes, at least two or more of the SQPs being dependent on data stored in respective tables in the operational nodes, with the SQP for a first operational node being different from the SQP for a second operational node.

9. The method of claim 8 where
the output of lists a number of alternate Query Plans constructed that are not the chosen Query Plan; and
the output command lists details of zero or more of the alternate Query Plans constructed.

10. The method of claim 8 where
the output lists a cost of the Query Plan; and
the output lists a costs of zero or more of the alternate Query Plans.

11. (canceled)

12. The method of claim 8 where two or more forms of output depend on modifiers provided in the command, including but not limited to a plaintext format, a tabular format, a graphical format, as a picture file, and as a result set in a specified geometry.

13. The method of claim 8 where the command to produce output of a Query Plan is an “EXPLAIN” command.

14. The apparatus of claim 1 wherein the operational nodes that implement the SQPs implement different databases so that the database management system is a heterogeneous distributed database.

15. The method of claim 8 wherein the operational nodes that implement the SQPs implement different databases so that the database management system is a heterogeneous distributed database.
